(19) United States
(12) Patent Application Publication
(10) Pub. No.: US 2008/0101095 A1
(43) Pub. Date: May 1, 2008

(54) Thunder mount

(76) Inventor: Gustavo Thunder Estravit, Thousand Oaks, CA (US)

Correspondence Address: GUSTAVO T. ESTRAVIT, 3165 LOS ROBLES ROAD, THOUSAND OAKS, CA, 91362, US

(21) Appl. No.: 11/501,268

(22) Filed: Oct. 17, 2006

(51) Int. Cl. E05F 11/00; H01R 33/00

(52) U.S. Cl. 362/648; 49/360

(57) ABSTRACT

Thunder Mount is a multi-fit overhead garage door opener mounting system. Thunder mount assembly is comprised of four parts.

Thunder Mounts top plate, has holes from which to attach bolts through to secure and suspended from a overhead truss, structure or support of the garage, and or building. Interconnecting shafts connect the top and bottom plates together. The bottom plate, has holes from where to attached a overhead garage door opener. All said parts are fastened together with nuts and bolts to create the Thunder Mount the first multi-fit adjustable overhead garage door opener mount. Said Thunder Mount has two attach points to attach more than one type of overhead garage door opener. Thunder Mount also has four unique doglegs from witch to attach two low voltage tracks and light fixtures.

Thunder Mount, as its called now is a multi-fit telescoping adjustable Overhead garage door opener mount.

Thunder mount is a multi-fit overhead garage door opener mount that attaches and is fastened from the overhead garage door

Opener, to the overhead structure of the garage, and or building.

Thunder Mount is comprised of four separate parts.

A base plate, a top plate and twin interconnecting shafts. There are two said interconnecting Shafts. One said interconnecting shaft is is 24 inches long and 2.0 inches round. The second said interconnecting shaft is 24 inches and 2.1 inches round. The said Shafts have adjustment holes every inch and can be lengthened and expanded from 24 inches to 46 inches in length.

The said embodiment of all these parts are fastened together with nuts and bolts to create the first multi-fit adjustable Overhead Garage Door Opener Mount.

The said top plate has holes from which to attach bolts through to secure the top plate To the structure, beams, joists of the garage and or building.

The said telescoping shafts connect the top plate to the bottom plate together with nuts and bolts. A overhead garage door opener is then fastened and attached to Thunder Mount.

All said parts of this assembly are punch pressed, rolled, and or extruded in various Steps and procedures to produce these parts.

FIG. 1. Base plate front elevation view of Thunder Mount.

FIG. 2. Base plate, right side elevation of Thunder Mount.

FIG. 3. Base plate, left side elevation of Thunder Mount.

FIG. 4. Base plate, backside elevation of Thunder Mount.

FIG. 5.Top plate, top view elevation of Thunder Mount.

FIG. 6. Interconnecting Shafts.

FIG. 7. Thunder Mount from below.

FIG. 8. see doglegs to attach low voltage tracks.

FIG. 9. Cad. Drawing of top and bottom plates.

FIG. 10 drawing of twin interconnecting shafts.

Thunder Mount is also the first said overhead garage door mount designed with four Dogleg Attach points to attach two low voltage tracks.

From the four-dog leg attach points two low voltage tracks can be attached and fastened. The power for the said low voltage tracks and lights will come from the said openers light sockets. Socket adapters will be provided in a low voltage lighting kit that I am Developing called Thunder Lightning Kit.

Also the twin interconnecting shafts are large enough to pass a power plug and the other Wires through that control the overhead garage door opener for a clean Professional look.

### BACKGROUND OF THE INVENTION

I Gus T. Estravit invented the original mount many years ago at my old house in Neenach, Calif. Around 1992. I went to the do-it your self-store to purchase an overhead garage door opener. After choosing the opener I was surprised to See that there wasn't a mount that I could purchase to mount it available. And there wasn't a mount for this type or any type of overhead garage door opener anywhere to be found. (And to this day there isn't a multi fit adjustable overhead garage door mount available, not a one of any type.)

I was directed to a different department of the store to get some type of metal to install my new opener. I was again surprised to see that there wasn't a Mount for these types of products. The choices of metals and sizes and shapes could Confuse any normal person, and not to mention figuring out how long to cut it and where to cut and how to mount and put all the pieces together. I've seen the different types of installation products and styles of work that is installed in many homes across America, and that wasn't the approach I was going to use to mount my new overhead garage door opener.

So I went back home and found some pieces of metal and started putting things Together. I came up with what I now call the Thunder Mount System.

At the time the mount was only a single idea but I soon realized that it was a Great place to attach some lights. And so then I decided to design it to fit other Types of overhead garage door openers.

And I believe it would be a new improvement and also a needed Product. And the other Idea concept and design of high intensity lighting and Low voltage lights to save money would make a great multi-multi fit mount. Thunder Mount is the first Multi-fit adjustable overhead garage door opener Mount and Low voltage track lighting mount. The first overhead Garage door Opener mount and a Low voltage track lighting mounting system in one.

### BRIEF SUMMARY OF THE INVENTION

Thunder Mount is the first Multi-fit adjustable overhead garage door opener Mounting kit System. The System is a easy and ready to use multi-fit fully Adjustable overhead garage Door opener mount that also is designed to hold two Low voltage tracks. The lighting kit is powered by the existing opener light Socket. A socket adapter is Included in the lighting kit I am Developing.

The way most overhead garage door opener are mounted is:

Electrical conduit is use to mount the opener.

The conduit is cut and hammered at the ends flat and then drilled and use to mount the opener. Some installations I have seen use plumbers tape. Plumbers tape is a metal strip with holes in it.

And some other installations use L shapes metal cut to size and also like the others none of the other type installation techniques are not a overhead garage door opener mount. Those mounting techniques are not a mount system of any kind and they don't look professional or safe at all.

### BRIEF DESCRIPTION OF SEVERAL VIEWS OR THE DRAWINGS

FIG. 1. Base plate front elevation view of Thunder Mount.

FIG. 2. Base plate, right side elevation of Thunder Mount.

FIG. 3. Base plate, left side elevation of Thunder Mount.

FIG. 4. Base plate, backside elevation of Thunder Mount.

FIG. 5.Top plate, top view elevation of Thunder Mount.

FIG. 6. Interconnecting Shafts.

FIG. 7. Thunder Mount from below.

FIG. 8 cad. Drawing of top plate and bottom plate.

### DETAILED DESCRIPTION OF INVENTION

Thunder Mount is the first Multi-fit adjustable overhead garage door opener Mounting kit System. The said mount system is easy and ready to use Multi-fit fully Adjustable overhead garage door opener mount that also is designed to hold two low voltage tracks. The lighting kit is powered by the existing opener light Socket. A socket adapter is Included in the lighting kit I'm Developing.

Thunder Mount is comprised of four separate parts.

The said base plate, the said top plate and said twin telescoping shafts. All the parts are fastened together with nuts and bolts to create Thunder Mount. The said top plate has holes from which to attach bolts through to securely attach, support, suspend the opener Mount.

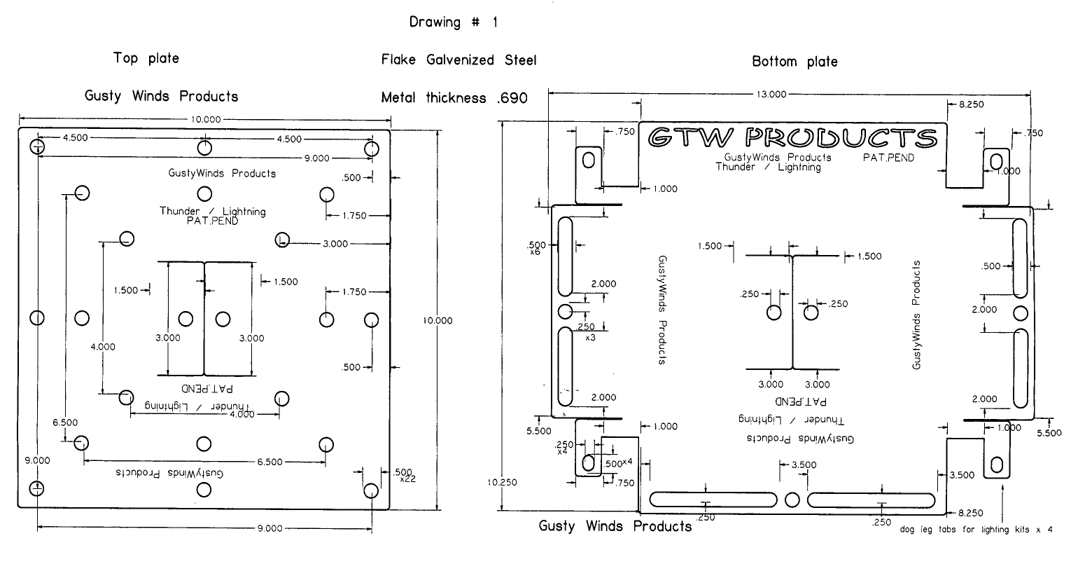

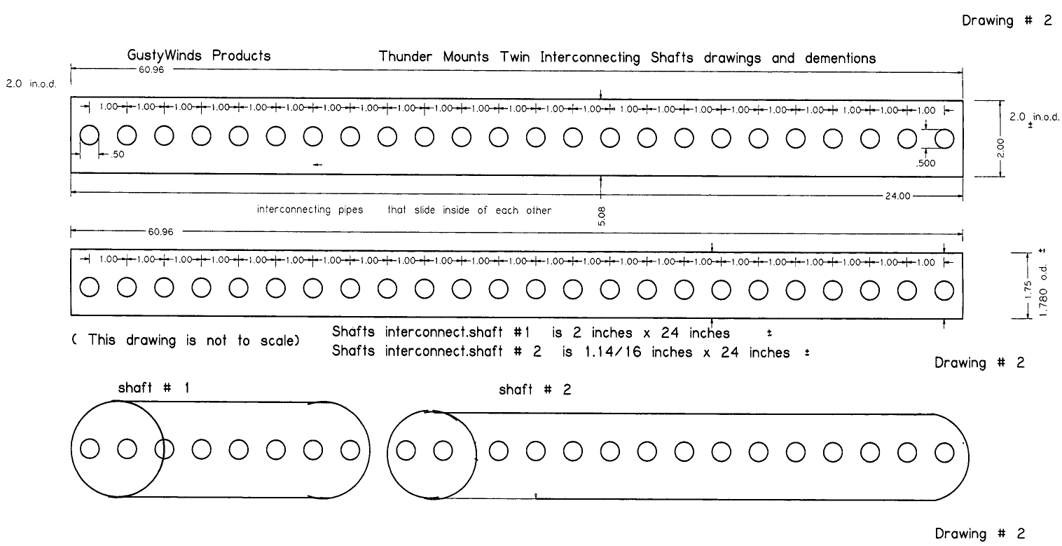

FIG. 1. Base plate front elevation view of Thunder Mount.

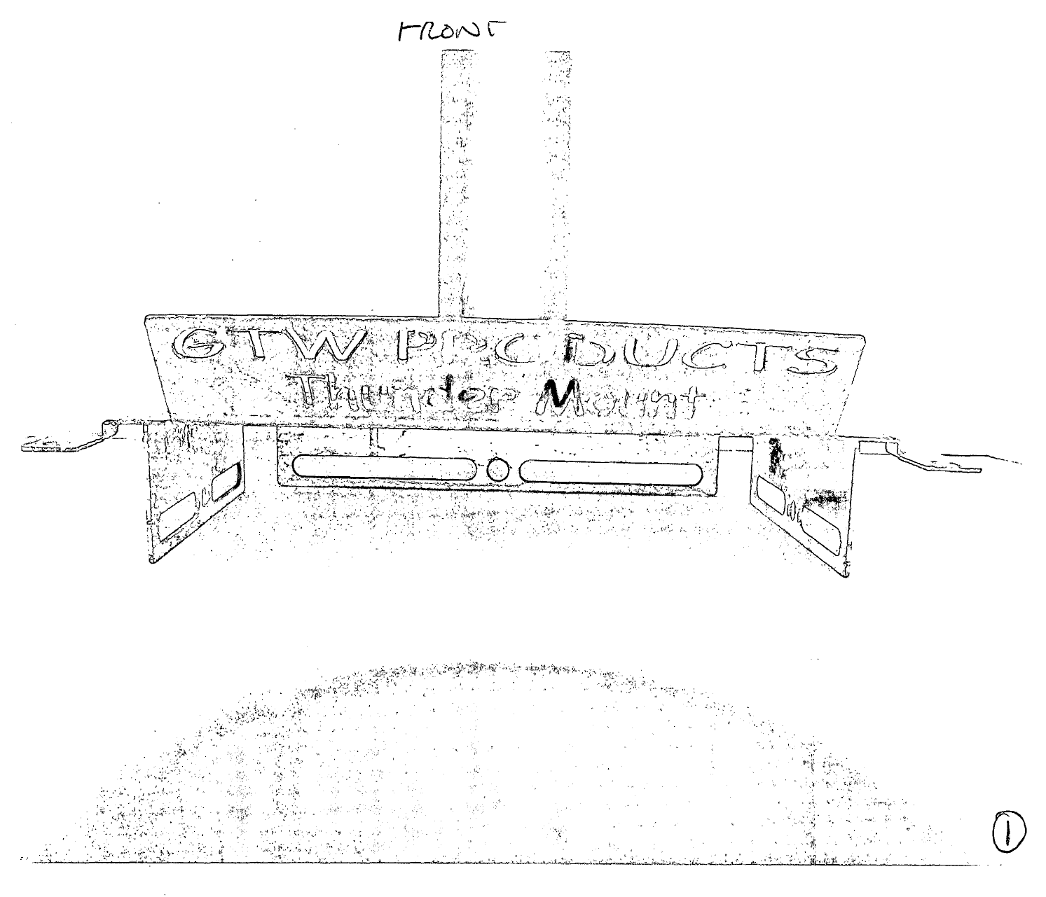

FIG. 2. Base plate, right side elevation of Thunder Mount.

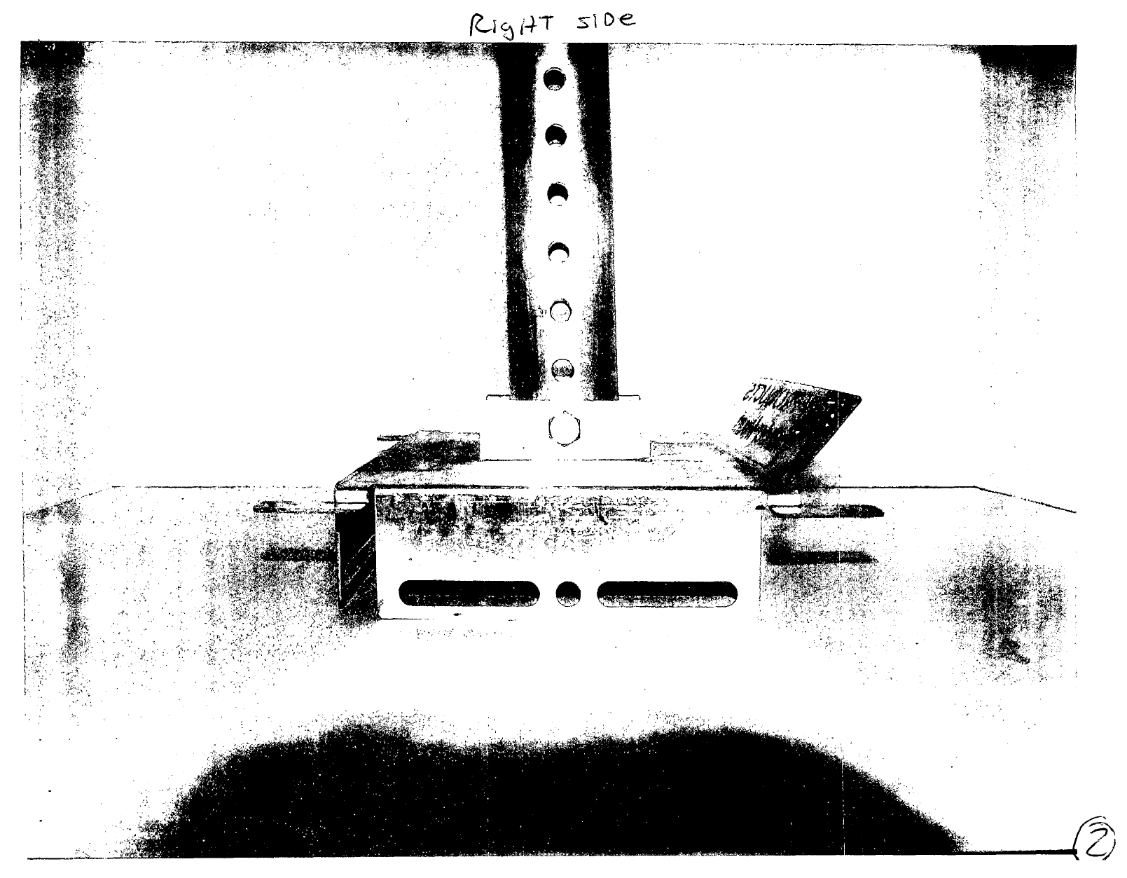

FIG. 3. Base plate, left side elevation of Thunder Mount.

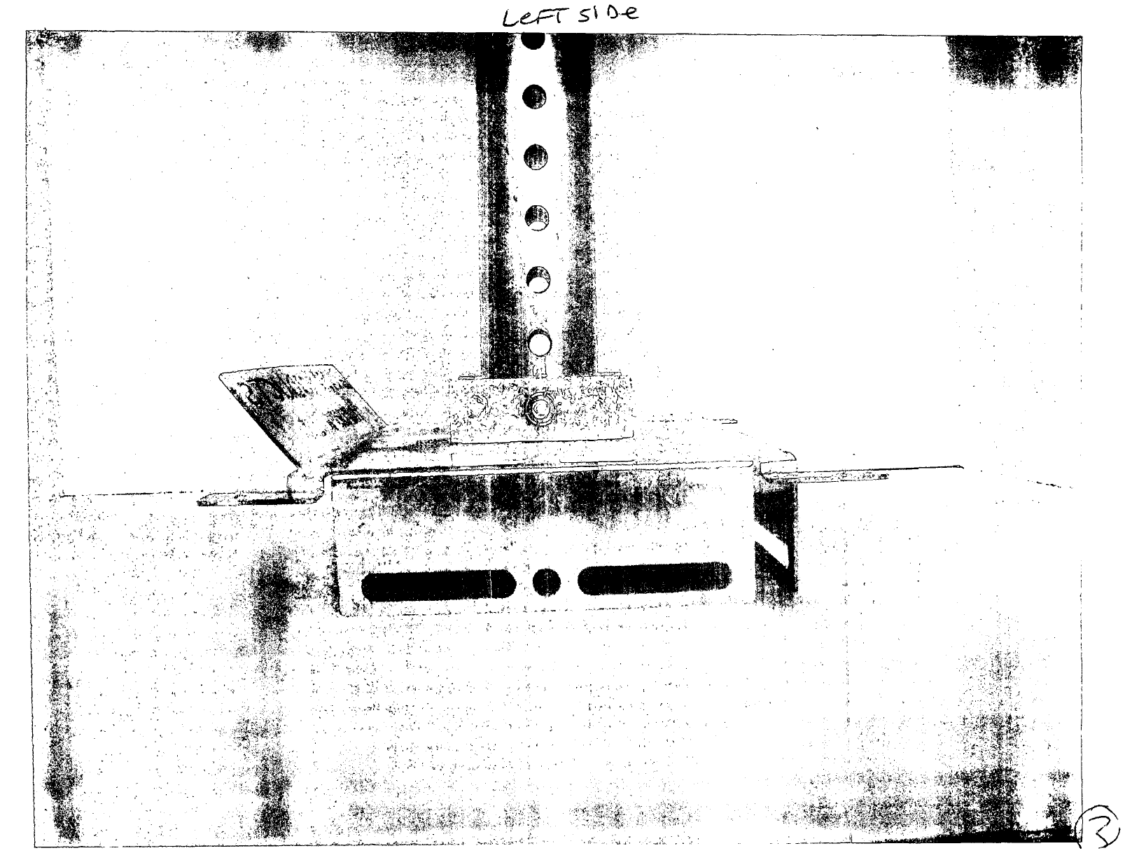

FIG. 4. Base plate, backside elevation of Thunder Mount.

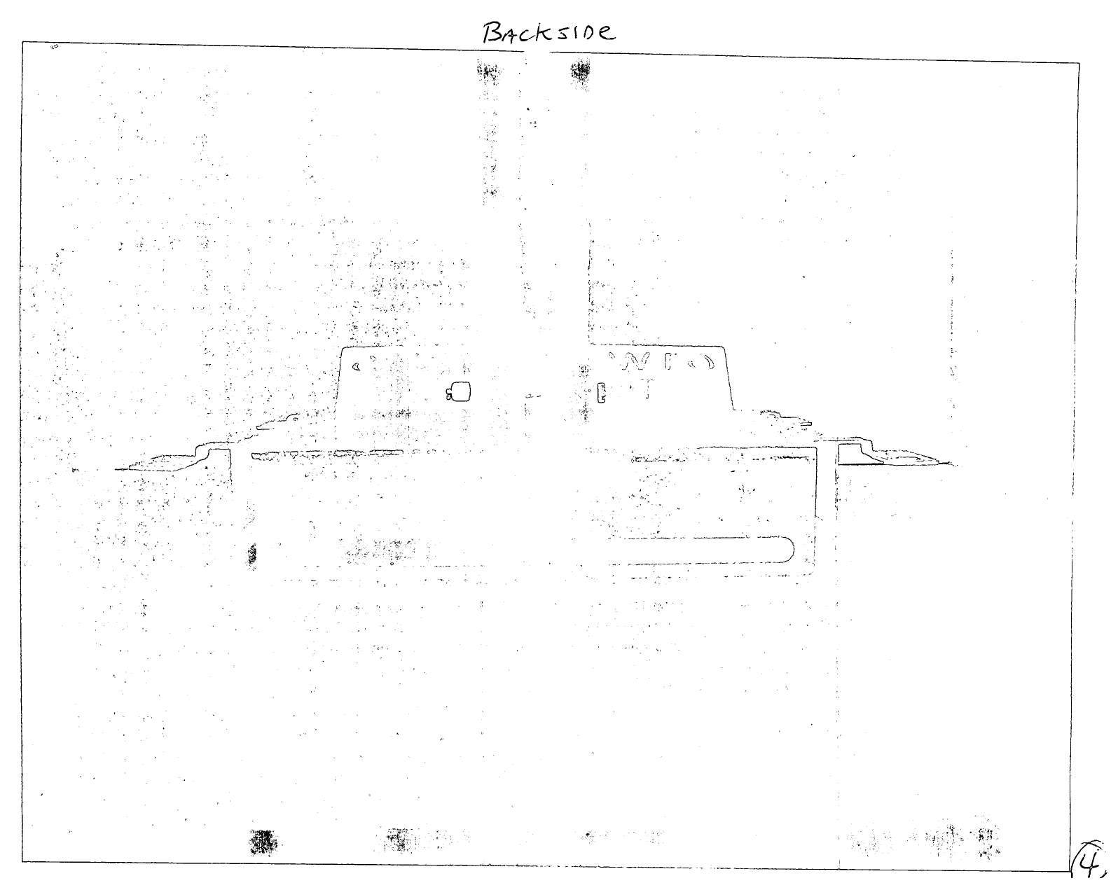

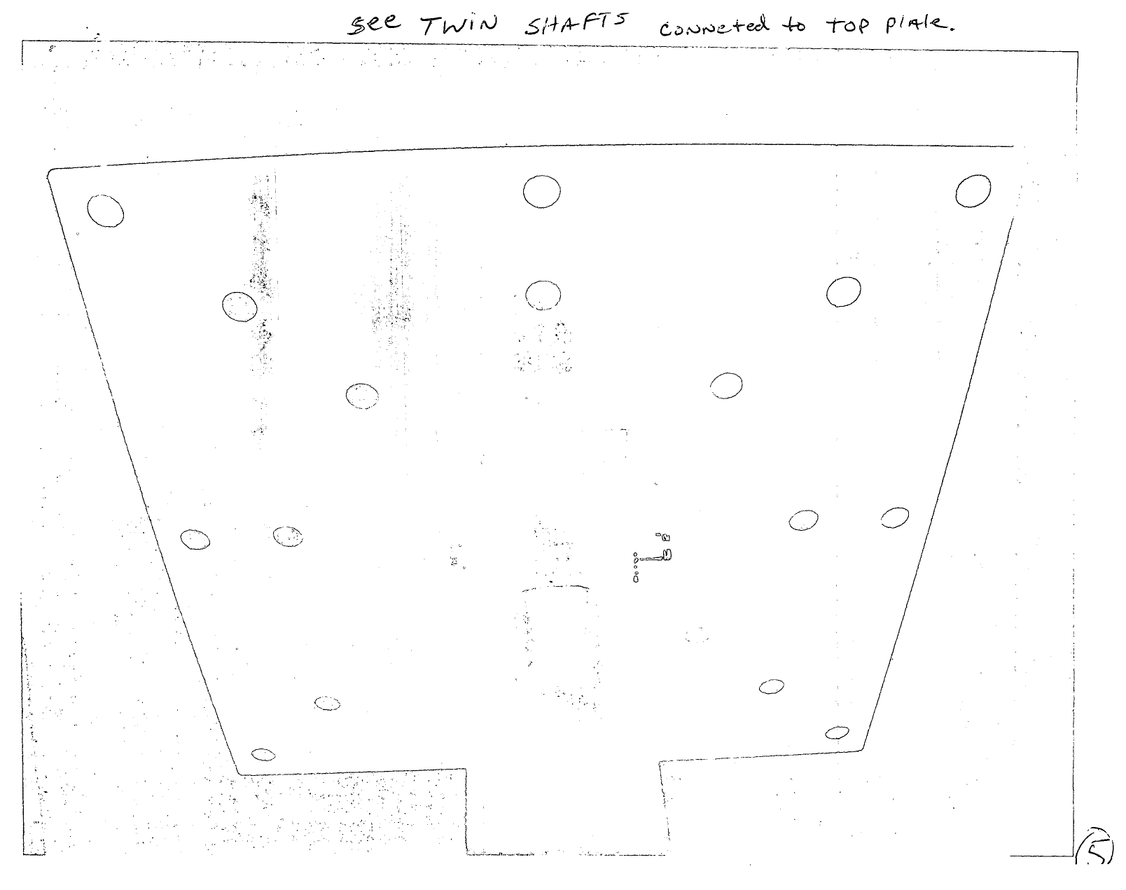

FIG. 5.Top plate, top view elevation of Thunder Mount.

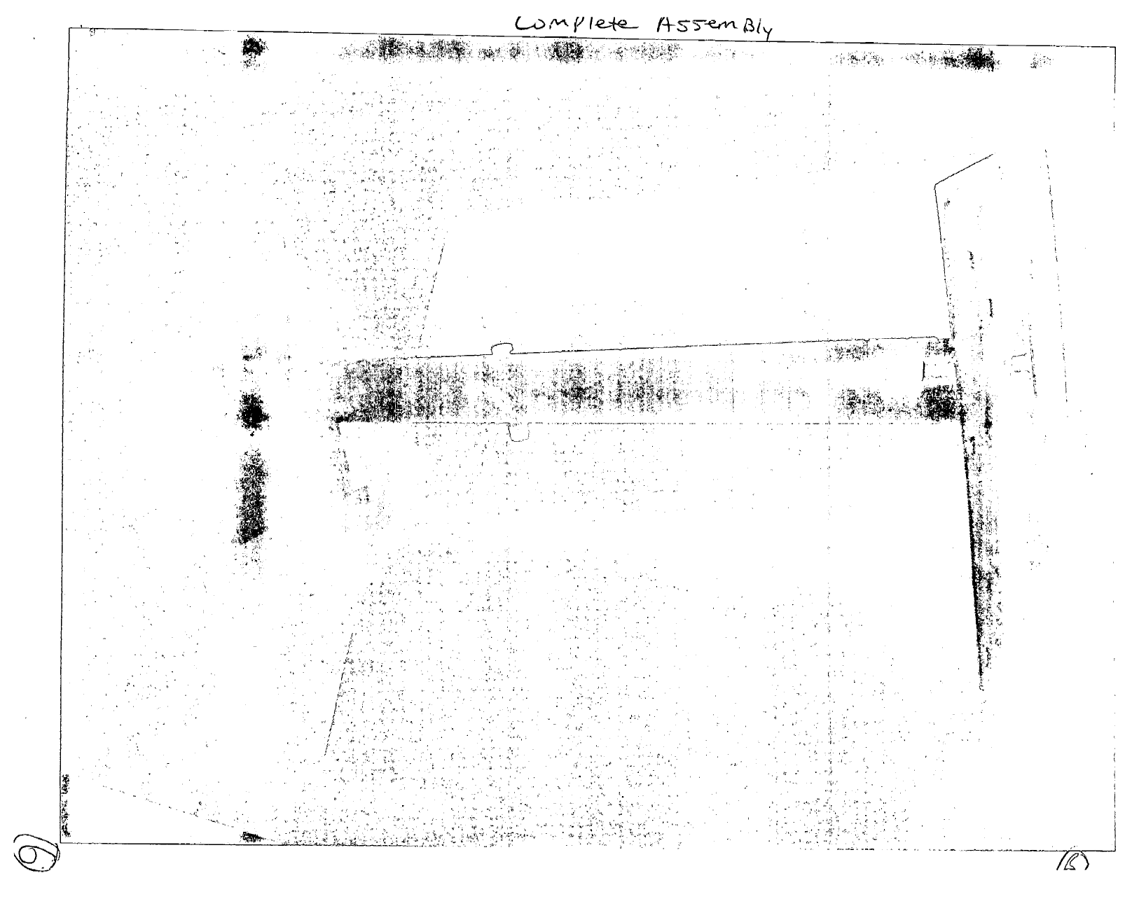

FIG. 6. Telescoping Shafts.

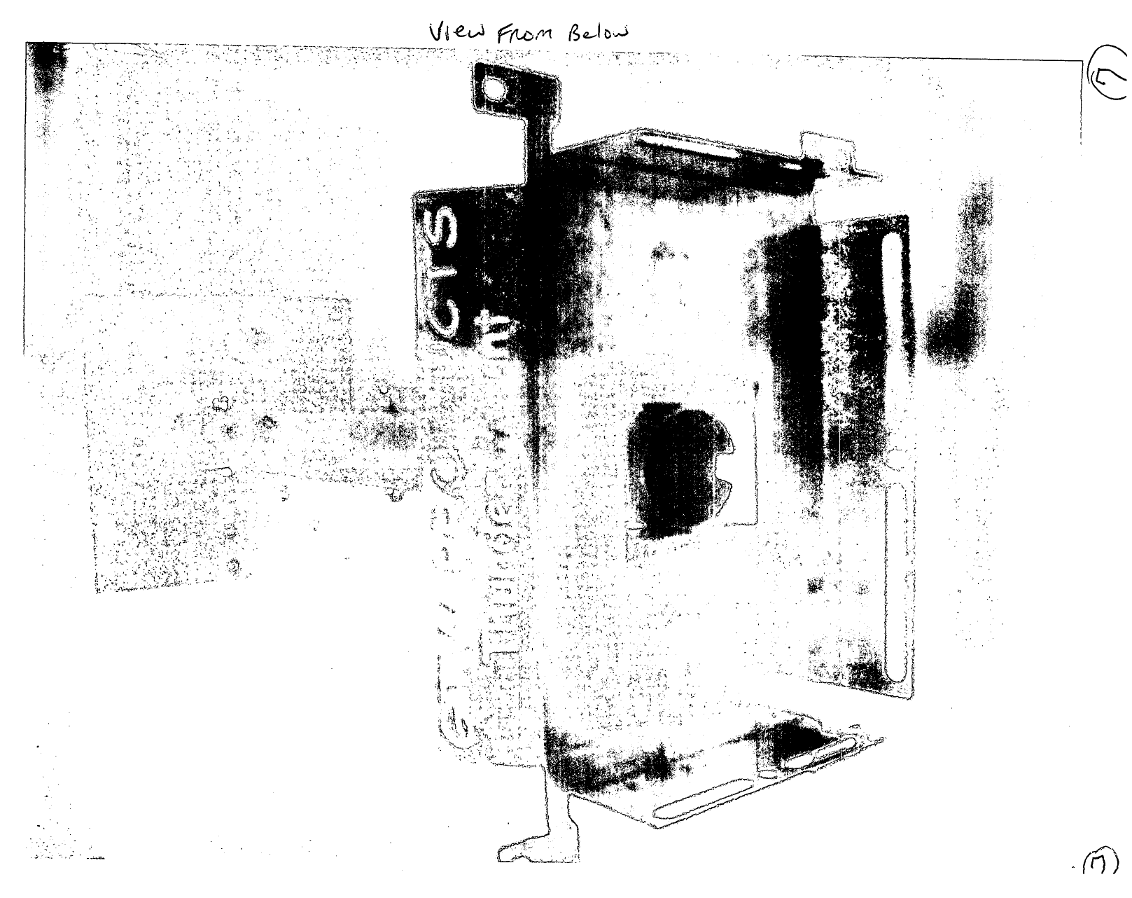

FIG. 7.Thunder Mount from below complete assembly.

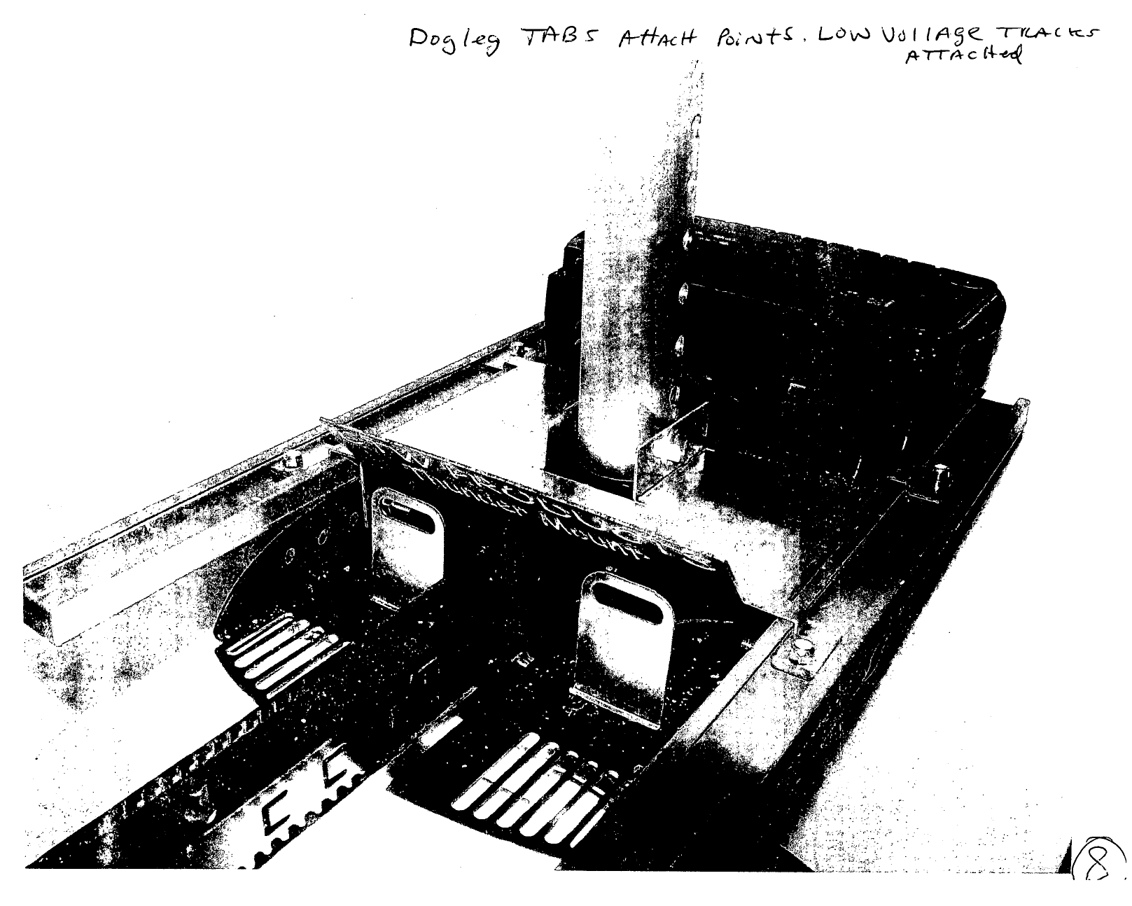

FIG. 8.Thunder Mount mounted to a overhead garage door opener with battery backup attached. And low voltage tracks attached to Thunder Mounts dog leg attach points.

FIG. 9. Thunder Mount top & bottom plate cad drawings.

FIG. 10. Twin shafts cad drawing.

What is claimed is:

1. A multi-fit adjustable overhead garage door opener mounting system. A multi-fit adjustable overhead garage door mount that holds, suspends, secures, attaches, supports from ceiling, joist or structure or building

2. A multi-fit overhead garage door opener mount that telescopes up and down for adjustability.

3. Thunder Mount, as its called now, is the first specially designed multi fit Adjustable Overhead Garage Door Opener Mounting System that incorporates the use and attachment of low voltage track lighting.

4. By also having attach points for low voltage tracks Thunder Mount is the first overhead garage door openers mount that also holds low voltage track lighting.

5. Thunder Mount is also the first overhead garage door mount designed with four Dogleg Attach points to attach two low voltage tracks.

6. Also claim to be the first to incorporate the use of the power source from the openers existing light socket to power the said low voltage lights and tracks that attach to the The Thunder Mount.
Socket adapters will be provided in a low voltage lighting kit I am Developing called Thunder Lightning kit.
Also the said twin interconnecting shafts are large enough to pass a power plug and the other wires through that control and power the overhead garage door opener for a unique clean professional look.
